(19) United States
(12) Patent Application Publication
(10) Pub. No.: US 2026/0264602 A1
(43) Pub. Date: Sep. 10, 2026

(54) HEADLAMP SYSTEM FOR MOBILE OBJECT

(71) Applicant: HYUNDAI MOBIS CO., LTD., Seoul (KR)

(72) Inventor: Myeong Je KIM, Youngin-si (KR)

(73) Assignee: HYUNDAI MOBIS CO., LTD., Seoul (KR)

(21) Appl. No.: 19/335,191

(22) Filed: Sep. 22, 2025

(30) Foreign Application Priority Data
Mar. 4, 2025 (KR) 10-2025-0027513

(51) Int. Cl. B60Q 1/14

(52) U.S. Cl. CPC B60Q 1/143; B60Q 2300/054; B60Q 2300/322; B60Q 2300/42

(57) ABSTRACT

The present disclosure relates to a headlamp system for a mobile object, and more specifically, may provide a headlamp system for a mobile object, including a controller configured to generate light pattern information based on external environmental information, and a light output device that includes a plurality of light sources and outputs a road surface projection image generated based on the light pattern information, in which the controller calculates light pattern information, which is data on an image of an update area changed compared to a previous road surface projection image based on the external environmental information, and provides the light pattern information to the light output device.

### CROSS REFERENCE TO RELATED APPLICATION

The present application claims priority to and the benefit under 35 USC § 119 (a) of Korean Patent Application No. 10-2025-0027513, filed Mar. 4, 2025, in the Korean Intellectual Property Office, the disclosure of which is incorporated herein by reference in its entirety for all purposes.

### BACKGROUND

### 1. Field

The present disclosure relates to a head lamp system for a mobile object.

### 2. Description of the Related Art

A headlight (headlamp) play a crucial role in securing driver visibility and preventing collisions with pedestrians and other vehicles at night. Conventional headlamp systems typically have high-beam and low-beam modes, and drivers manually switch between modes or use an automatic switching function to select an appropriate beam pattern under driving conditions. Recently, an adaptive driving beam (ADB) system has been introduced, evolving a technology for adjusting a beam pattern depending on the presence of nearby vehicles and pedestrians. The ADB system includes a camera, a distance sensor, a controller, and multiple individually adjustable light-emitting diode (LED) matrix light sources and detects oncoming or preceding vehicles to block light in only an area in which the corresponding vehicle is positioned, thereby securing the driver's visibility and preventing glare to other drivers. Conventional ADB systems use a sensor module of a vehicle to recognize a road environment in real time, acquire position information on nearby vehicles, and then, based on the collected data, control individual light sources in the LED matrix to attenuate or block light in specific areas, creating shadow areas, transmit generated light pattern information to the ADB system to adjust the output of the light source.

However, despite their focus on detecting a real-time road environment and maintaining optimal lighting patterns, the conventional ADB systems have several technical limitations.

The conventional ADB systems are operated by newly generating and updating the entire light pattern information for each frame, thereby unnecessarily increasing data processing and slowing down real-time response times. In particular, since the entire beam pattern is reset even when only some pixels have been changed compared to a previous frame, unnecessary data processing and computational load occur. In addition, the conventional systems lack the sophistication to detect changes in shadow areas, which results in unnecessary beam blocking and, consequently, reduced driver visibility.

In addition, there are limitations in effectively adjusting lighting patterns when a vehicle travels on a curved road. The conventional ADB systems are designed primarily for detecting oncoming vehicles on straight roads, and thus can inaccurately set shadow areas on curved roads, failing to adequately cover oncoming vehicles or, conversely, blocking unnecessary areas. In addition, a function of predicting a traveling trajectory using steering wheel angle information of a vehicle is inadequate, which can prevent lighting patterns from responding immediately to environmental changes at high speed.

Consequently, the conventional ADB systems have limitations in that bandwidth usage is increased due to unnecessary data transmission, real-time response times are likely to be degraded, and responsiveness to curved roads or rapid changes in driving environments is insufficient.

### SUMMARY

The present disclosure is directed to providing a headlamp system for a mobile object, which can improve real-time responsiveness by reducing an amount of data of transmitted light pattern information, reduce computational load, and reduce material costs through simplification of signal processing circuits or communication modules.

According to various embodiments of the present disclosure, there is provided a headlamp system for a mobile object, including a controller configured to generate light pattern information based on external environmental information, and a light output device that includes a plurality of light sources and outputs a road surface projection image generated based on the light pattern information, in which the controller calculates light pattern information, which is data on an image of an update area changed compared to a previous road surface projection image based on the external environmental information, and provides the light pattern information to the light output device.

In addition, the light output device may generate a road surface projection image by selectively updating an image in the update area based on the light pattern information and maintaining the image in the remaining areas based on a previous road surface projection image.

In addition, the controller may set a changed shadow area as the update area when a change between a shadow area calculated from the external environmental information and a previous shadow area is detected and provide light pattern information including coordinate data of the update area to the light output device.

In addition, the controller may detect a change in the shadow area based on a time-dependent difference in position information of an oncoming vehicle acquired from the external environmental information.

In addition, the controller may calculate position information of an oncoming vehicle in the road surface projection image based on angle information and distance information of the oncoming vehicle acquired from the external environmental information.

In addition, the headlamp system may further include a memory connected to the light output device and the controller, wherein the memory may include a plurality of buffers, the controller may alternately select the plurality of buffers to modify or correct a basic image of the road surface projection image and stores the light pattern information, the light output device may output light using light pattern information already stored in at least one of the other buffers while the controller stores the light pattern information in one of the plurality of buffers, and when the controller completes storing the light pattern information in the any one of the buffers, cyclic switching between the buffers may be performed so that the buffer in which storage has been completed is usable for light output.

In addition, the controller may acquire a lane width of a driving road based on the external environmental information and generate the light pattern information by correcting a trapezoidal basic image in consideration of the lane width.

In addition, the controller may acquire a curvature of the driving road based on the external environmental information and determine whether the driving road is a straight road or a curved road and when the driving road is the curved road, correct the trapezoidal basic image in consideration of the lane width and the curvature to generate the light pattern information.

In addition, the controller may generate curvature information of left and right lane lines of the driving road by applying the following Equation 3 to the left lane line and the right lane line, respectively, based on a curvature coefficient {A₀, . . . , Aₙ} of the left lane line or the right lane line of the driving road included in the external environmental information, and generate the light pattern information by correcting the trapezoidal basic image in consideration of the curvature information.

$$Y = {\sum }_{i = 0}^{n} {A}_{i} \cdot {X}^{( n - i )} \qquad [ Equation 3 ]$$

(where X denotes lateral (width direction of a vehicle) positions of the left and right lane lines of the driving road, and Y denotes longitudinal (longitudinal direction of the vehicle) positions according to the lateral positions of the left and right lane lines of the driving road).

In addition, the controller may divide the road surface projection image into a plurality of groups, identify an update area changed compared to a previous road surface projection image based on the external environmental information, determine a group including the update area, and calculate light pattern information on an image of the determined group and provide the light pattern information to the light output device.

### BRIEF DESCRIPTION OF THE DRAWINGS

FIG. 1 is a schematic view illustrating a headlamp system for a mobile object according to the present disclosure.

FIG. 2 is a schematic view illustrating a change in an output of a light output device according to a change in a shadow zone according to the present disclosure.

FIG. 3 is a schematic view illustrating a method of calculating position information of an oncoming vehicle according to the present disclosure.

FIG. 4 is a schematic view illustrating an image processing process of an internal memory according to the present disclosure.

FIG. 5 is a schematic view illustrating a lane curvature that changes according to lane information of external environmental information according to the present disclosure.

FIG. 6 is a schematic view illustrating a road surface projection image output according to FIG. 5.

FIG. 7 is a schematic view illustrating a lane curvature that changes according to a steering angle of a steering wheel according to the present disclosure.

FIGS. 8A and 8B are schematic views illustrating a method of adjusting a shadow area according to the present disclosure.

### DETAILED DESCRIPTION

To describe the present disclosure, operational advantages of the present disclosure, and objects achieved by the implementation of the present disclosure, hereinafter, exemplary embodiments of the present disclosure will be exemplified and described with reference to the embodiments.

First, terms used in this application are only used to describe specific embodiments and are not intended to limit the present disclosure, and singular expressions may include plural expressions unless the context clearly indicates otherwise. In addition, in this application, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In describing the present disclosure, when it is determined that the detailed description of related known configurations or functions may obscure the gist of the present disclosure, detailed description thereof will be omitted.

The present disclosure relates to a differential update method of a headlamp system for a mobile object. In particular, the present disclosure provides a technology for adjusting a shadow area in real time based on external environmental information of a vehicle, optimizing a light output pattern, and differentially updating the light output pattern according to a change in specific environment. Accordingly, optimal visibility can be maintained without disturbing drivers of oncoming vehicles. The conventional adaptive driving beam (ADB) systems simply block a predetermined area when an oncoming vehicle is detected, but the present disclosure improves the above method by providing more precise control to block only the minimum necessary area and reflect changes in real time.

Hereinafter, a headlamp system 1000 for a mobile object according to the present disclosure will be described in detail.

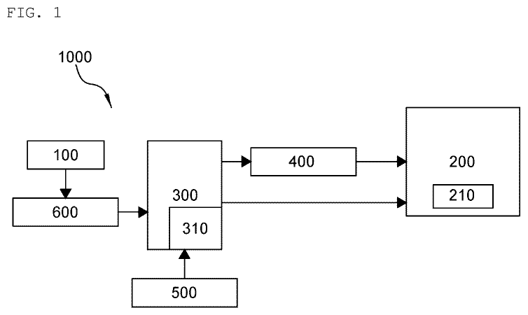

FIG. 1 is a schematic view illustrating the headlamp system 1000 for a mobile object according to the present disclosure.

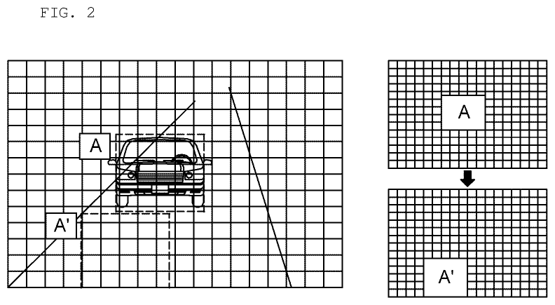

FIG. 2 is a schematic view illustrating a change in an output of a light output device according to a change in a shadow zone according to the present disclosure.

As illustrated in FIG. 1, the headlamp system 1000 for a mobile object according to the present disclosure may include a sensor module 100, a light output device 200, and a controller 300.

The sensor module 100 may include an advanced driver assistance system (ADAS) sensor for acquiring external environmental information of a vehicle. Specifically, the sensor module 100 may include a camera or a distance detection sensor, which may provide external environmental information, such as road conditions, lane markings, nearby vehicles, pedestrians, traffic signals, weather conditions, and the like, but is not limited thereto. Meanwhile, the headlamp system 100 for a mobile object of the present disclosure includes the sensor module 100 in the drawing, but the sensor module 100 may be provided outside the headlamp system 1000 for a mobile object according to the present disclosure.

The light output device 200 includes a plurality of light sources and may output a road surface projection image based on light pattern information by implementing pixel-by-pixel lighting based on a light source matrix. Specifically, the optical output device 200 may generate a road surface projection image by selectively updating only an image of an update area among road surface projection images from a previous time point based on the light pattern information and maintaining the remaining areas.

The controller 300 may control the light output device 200 based on external environmental information acquired from the sensor module 100 or an external device. Specifically, the controller 300 may compare a previous road surface projection image with a current road surface projection image based on the external environmental information and calculate light output data, which is data on the image of the update area that has been changed compared to the previous road surface projection image, and provide the calculated light output data to the light output device 200. In this case, the light pattern information may include coordinate data of the update area. Accordingly, it is possible to optimize processing efficiency and power consumption by eliminating the need to regenerate the entire road surface projection image each time.

Specifically, as illustrated in FIG. 2, the controller 300 may analyze positional information of an oncoming vehicle from continuously acquired external environmental information to calculate a shadow area (A: initial shadow zone, A′: changed shadow zone), and the controller 300 may compare a shadow area of the previous road surface projection image with the currently calculated shadow area and set only the shadow area whose change is detected as an update area. In addition, light pattern information including the coordinate data of the update area may be provided to the light output device 200.

The conventional ADB systems set a new shadow area for all frames, but in the present disclosure, it is possible to minimize computational load and increase a response time by processing only the shadow area whose change is detected as an update area. This enables immediate shadow application when an opposing vehicle is detected, reducing unnecessary computation and power consumption.

In this case, the controller 300 may use angle and distance information to precisely calculate the positional information of the oncoming vehicle. The controller 300 may extract an angle and distance of the oncoming vehicle based on the external environmental information and based on this, may calculate the position information of the oncoming vehicle.

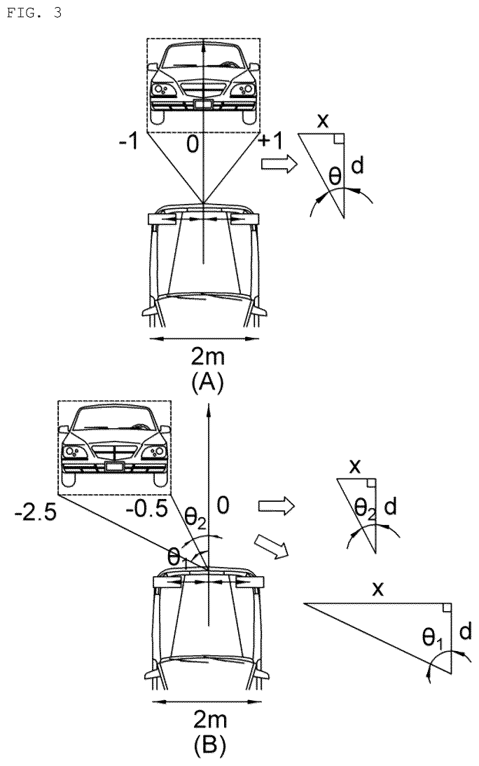

FIG. 3 is a schematic view illustrating a method of calculating position information of an oncoming vehicle according to the present disclosure.

Specifically, as illustrated in FIG. 3, the controller 300 may convert angle θ and distance information (forward distance) of the oncoming vehicle extracted based on the external environmental information into angle information based on the light output device 200, thereby calculating the position information of the oncoming vehicle in the road surface projection image.

More specifically, the sensor module 100 measures the angle information θ, which is a directional angle indicating how far the oncoming vehicle deviates left or right from a reference line (center) of the sensor module (e.g., a camera), and a forward distance d, which is a straight-line distance from the oncoming vehicle.

In FIG. 3A, when the reference lines of the oncoming vehicle and the driving vehicle coincide, for example, when a rightward heading angle of the oncoming vehicle detected by the camera from the reference line is 1.15°, a leftward heading angle of the oncoming vehicle is −1.15°, and a forward distance is 50 m, the controller 300 may calculate a lateral position x, which is the position information of the oncoming vehicle, based on such information

Based on the center of the vehicle, the lateral position (position of the vehicle in a width direction) of the vehicle may be calculated using the following Equation 1 using angle information and distance information.

$$Lateral position = tan ( θ ) \times distance \qquad [ Equation 1 ]$$

In the above example, when the angle is 1.15° and the forward distance is 50 m,

$$Lateral position ( rightward ) = tan ( 1.15 ° ) \times 50 m \approx 1 m$$

In addition, when the angle is −1.15° and the forward distance is 50 m,

$$Lateral position ( leftward ) = tan ( - 1.15 ° ) \times 50 m \approx - 1 m$$

That is, the oncoming vehicle is positioned between about 1 m and −1 m with respect to the reference line of the camera.

In this case, assuming that the light source is about 0.7 m to both sides of the vehicle's center, the lateral positions with respect to the light source may be 1.7 m (1 m+0.7 m) and −0.3 m (−1 m+0.7 m), respectively.

The controller 300 may convert the lateral position obtained in this way into an angle (θ′) with respect to the light source using the following Equation 2.

$${θ}^{′} = {tan}^{- 1} ( \frac{lateral position ( with respect to light source )}{distance} ) \qquad [ Equation 2 ]$$

For example, when the lateral position is −0.3 m, the lateral position of −0.3 m and the distance of 50 m may be substituted into Equation 2 to calculate about −0.34°. In addition, when the lateral position is 1.7 m, the lateral position of 1.7 m and the distance of 50 m may be substituted into Equation 2 to calculate the light source angle corresponding to about +1.95°.

In FIG. 3B, when the reference lines of the oncoming vehicle and the driving vehicle do not coincide, for example, when a rightward heading angle of the oncoming vehicle detected by the camera from the reference line is −0.57° (θ₂), a leftward heading angle of the oncoming vehicle is-2.86° (θ₁), and a forward distance is 50 m, the controller 300 may calculate a lateral position, which is the position information of the oncoming vehicle, based on such information.

Based on the center of the vehicle, the lateral position (position of the vehicle in a width direction) of the vehicle may be calculated using the following Equation 1 using angle information θ and distance information.

In the above example, when the angle is −0.57° and the forward distance is 50 m,

Lateral position (rightward)=tan(−0.57°)×50 m≈−0.5 m

In addition, when the angle is −2.86° and the forward distance is 50 m,

Lateral position (leftward)=tan(−2.86°)×50 m≈−2.5 m

That is, the oncoming vehicle is positioned between about −0.5 m and −2.5 m with respect to the reference line of the camera.

In this case, assuming that the light source is about 0.7 m to both sides of the vehicle's center, the lateral positions with respect to the light source may be 0.2 m (−0.5 m+0.7 m) and −1.8 m (−2.5 m+0.7 m), respectively.

The controller 300 may convert the lateral position obtained in this way into an angle (θ′) with respect to the light source using the following Equation 2.

For example, when the lateral position is 0.2 m, the lateral position of 0.2 m and the distance of 50 m may be substituted into Equation 2 to calculate about 0.23°. In addition, when the lateral position is −1.8 m, the lateral position of −1.8 m and the distance of 50 m may be substituted into Equation 2 to calculate the light source angle corresponding to about −2.06°.

Accordingly, more precise control can be possible by not simply using the angle and distance information obtained from the camera, but also converting such information into a lateral position, and then converting the lateral position back into a reference angle of the light source to calculate the position information of the oncoming vehicle.

The present disclosure assigns a plurality of buffers to a memory (hereinafter, an internal memory (random access memory (RAM)) 310) to enable real-time adjustment of the shadow area.

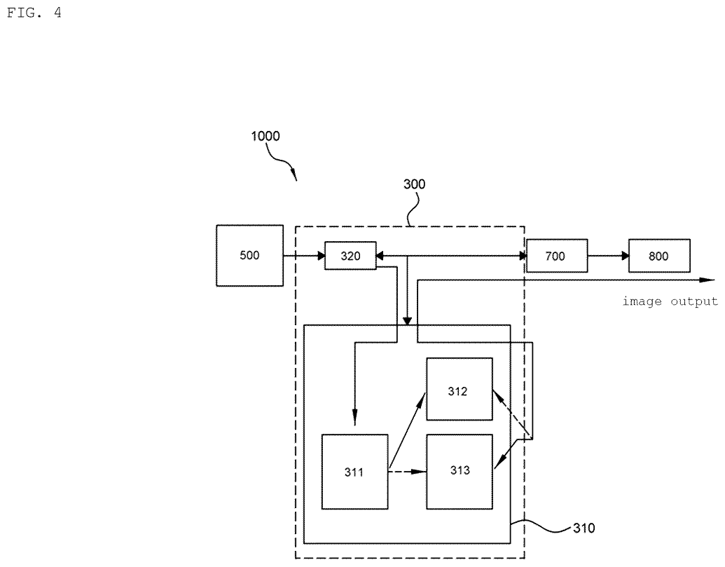

FIG. 4 is a schematic view illustrating an image processing process of an internal memory according to the present disclosure.

Specifically, as illustrated in FIG. 4, three buffers may be assigned, and a first buffer (Buffer1) 311 is a buffer assigned to a first area, stores a basic image of the ADB, and includes an image in a fully turned-on state. A second buffer (Buffer2) 312 and a third buffer (Buffer3) 313 are assigned to second and third areas, respectively, and may be switched alternately to reflect the position of the oncoming vehicle and current road information (lane width and curvature) to update the road surface projection image. In this case, Buffer2 may store the image being currently warped, and Buffer3 may store the warped image to update the road surface projection image in real time, and in addition, Buffer2 and Buffer3 may be controlled to alternately perform their roles by switching SW1 and SW2.

For example, while SW1 selects Buffer2 among Buffer2 and Buffer3 and warps Buffer2, SW2 may select Buffer3 and allow the image stored in Buffer3 to be transmitted to the light output device 300. Thereafter, SW1 and SW2 are connected to Buffer3 and Buffer2, respectively, so that, while the controller 300 generates a warped image in Buffer3 using the original image, the light output device 300 may selectively output the image in Buffer2, which is the warped image.

Accordingly, by alternately using a plurality of buffers within the memory 310 connected to the light output device 200 and the controller 300, one buffer updates image data while the other buffer stably outputs light, preventing conflicts between data storage and output and ensuring real-time system performance.

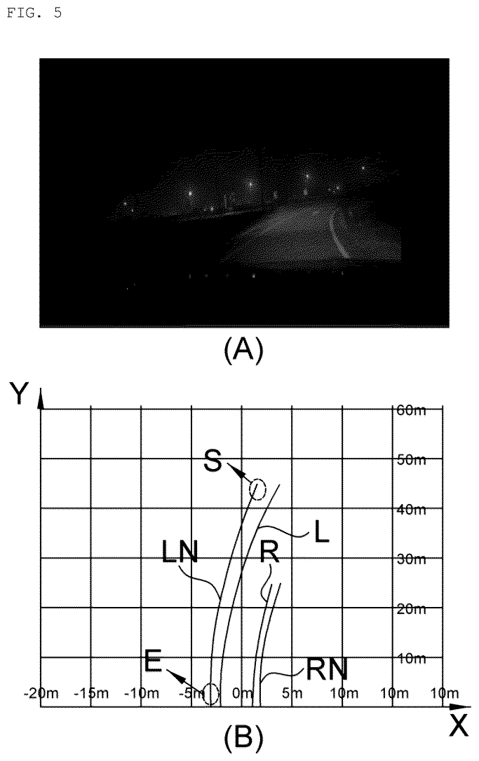

FIG. 5 is a schematic view illustrating a lane curvature that changes according to lane information of external environmental information according to the present disclosure.

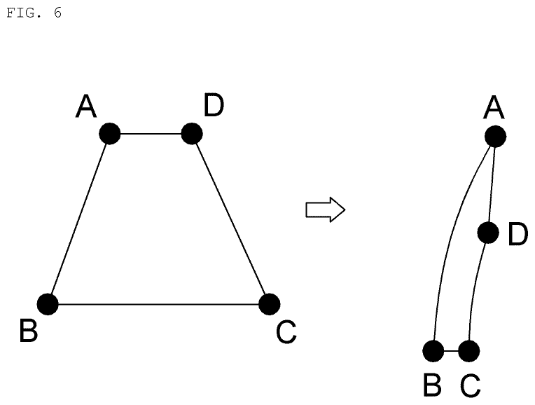

FIG. 6 is a schematic view illustrating a road surface projection image output according to FIG. 5.

The controller 300 may acquire lane curvature information of the road on which the vehicle is traveling from the external environmental information and generate light pattern information. Based on this, the road surface projection image can be more precisely adjusted to maintain a stable light output pattern even when driving on a curve.

Specifically, in order to effectively adjust the lighting pattern of the headlamp when a vehicle travels on a straight or curved road, in the present disclosure, a basic trapezoidal image is stored and output if necessary. In this case, the controller 300 may acquire the lane width of the driving road based on the external environmental information and correct the trapezoidal image in consideration of the acquired lane width to generate light pattern information.

More specifically, the controller 300 may acquire the lane width of the driving road based on the external environmental information and may also acquire the curvature of the driving road. Based on the acquired curvature, it is possible to determine whether the current road is a straight road or curved road, and when the driving road is the curved road, the trapezoidal basic image may be corrected in consideration of the lane width and curvature to generate light pattern information.

For example, when determining that a road on which a vehicle is currently traveling is a curved road as illustrated in FIG. 5A, as illustrated in FIG. 5B, the controller 300 may generate curvature information of a left lane line of the driving road by applying the following Equation 3 to the left lane line using a curvature coefficient {A₀, . . . , Aₙ} of a polygonal function representing a curvature of the left lane line of the driving road included in the external environmental information. In addition, the controller 300 may generate curvature information of a right lane line of the driving road by applying the following Equation 3 to a right lane line using the curvature coefficient {A₀, . . . , Aₙ} of the polygonal function representing the curvature of the right lane line of the driving road included in the external environmental information.

$$Y = {\sum }_{i = 0}^{n} {A}_{i} \cdot {X}^{( n - i )} \qquad [ Equation 3 ]$$

(where X denotes lateral (width direction of a vehicle) positions of the left and right lane lines of the driving road, and Y denotes longitudinal (longitudinal direction of the vehicle) positions according to the lateral positions of the left and right lane lines of the driving road).

For example, as shown in FIG. 5B, when the vehicle is traveling on a three-lane road in a second lane, it may be represented by four polynomial functions: L (Left) denotes a left lane line of the second lane, R (Right) denotes a right lane line of the second lane, LN (LeftNext) denotes a right lane line of a first lane, and RN (RightNext) denotes a right lane line of a third lane (S: Start, E: End).

Thereafter, using the generated curvature information, as illustrated in FIG. 6, the trapezoidal basic image may be corrected based on the lane lines (Left, Right) to which the vehicle belongs, generating light pattern information reflecting the curvature information (A: left start point, B: left end point, C: right end point, D: right start point).

Accordingly, it is possible to minimize the delay in light adjustment before the vehicle enters a curved road, thereby improving driving stability and maximizing visibility. In addition, since the curvature information is reflected in real time, unlike the conventional reactive pattern adjustment method that adjusts a position of a vehicle based on a change in the position of the vehicle, proactive adjustment is possible, resulting in faster response times.

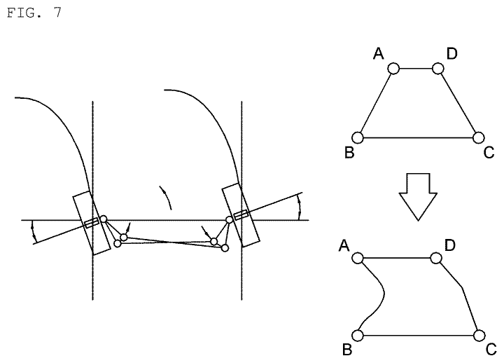

FIG. 7 is a schematic view illustrating a lane curvature that changes according to a steering angle of a steering wheel according to the present disclosure (A: left start point, B: left end point, C: right end point, D: right start point).

As illustrated in FIG. 7, a driving route of the vehicle changes in real time according to a steering angle of a steering wheel. Accordingly, in the present disclosure, a method of calculating an estimated traveling trajectory of a vehicle by reflecting steering wheel angle information in real time and based on this, calculating light pattern information is applied. Accordingly, it is possible to maximize the driver's visibility while minimizing the impact of lighting on oncoming or nearby vehicles.

When the vehicle travels, a steering angle of the steering wheel is a key information that determines the traveling direction of the vehicle. When the steering angle is 0 degrees (neutral), the vehicle travels on a straight road, and as the steering angle increases, the moving trajectory of the vehicle changes. Based on this, a process of monitoring the steering angle of the steering wheel in real time and calculating an estimated traveling trajectory is as follows.

First, the controller 300 may collect steering angle and external environmental information in real time through steering wheel sensor and ADAS sensors (a camera, a distance sensor, and the like) of the vehicle, respectively. Then, a mathematical model may be applied to predict a current traveling trajectory in consideration of a steering angle and a vehicle speed. When the vehicle travels on a straight road with a steering angle close to 0 degrees, the estimated traveling trajectory of the vehicle maintains the center of the lane, and thus the road surface projection image may be output as a trapezoidal image, which is the basic image.

When the steering angle of the steering wheel increases and the vehicle turns right, the center of a forward field of view shifts to the right, changing the curvature of the lane on which the vehicle will travel. When a basic trapezoidal image based on straight driving is maintained, there is a risk of excessive blockage of light in the right lane line or inadequate light distribution for oncoming vehicles. Accordingly, by reflecting the curvature of the right and left lane lines in consideration of the traveling direction of the vehicle during a right turn, the basic image may be corrected to generate light pattern information. In addition, when an oncoming vehicle is present, additional light pattern information for the shadow area may be generated in consideration of the relative position with the oncoming vehicle.

Conversely, when the vehicle turns left, the center of the forward field of view shifts to the left, causing the estimated traveling trajectory to curve to the left. When the basic trapezoidal image, which is the same as that used for straight driving, is maintained, a relationship with the left lane line may be misaligned, resulting in an unbalanced light distribution. Accordingly, by reflecting the curvature of the left and right lane lines, the basic image may be corrected to generate light pattern information. In addition, when an oncoming vehicle is present, additional light pattern information for the shadow area may be generated in consideration of the relative position with the oncoming vehicle.

The differential update method of this system is also applicable to such curved roads, and a method of correcting the basic image to generate light pattern information according to the predicted curvature change based on the traveling trajectory and adjusting the light output device 200 is applied. Accordingly, unnecessary lighting changes can be reduced, thereby enabling rapid response to a change in the position of an oncoming vehicle or a change in lane curvature. This method is particularly effective in adjusting the lighting pattern in real time without computational delay on roads with high driving speeds or large curvatures and can contribute to minimizing glare to oncoming vehicles while maintaining driver visibility.

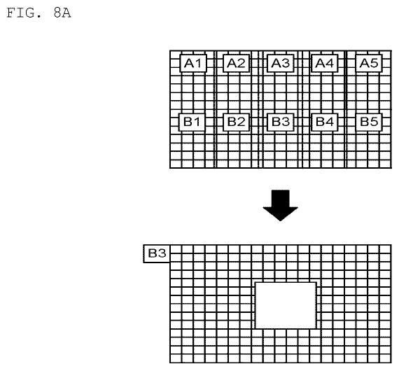

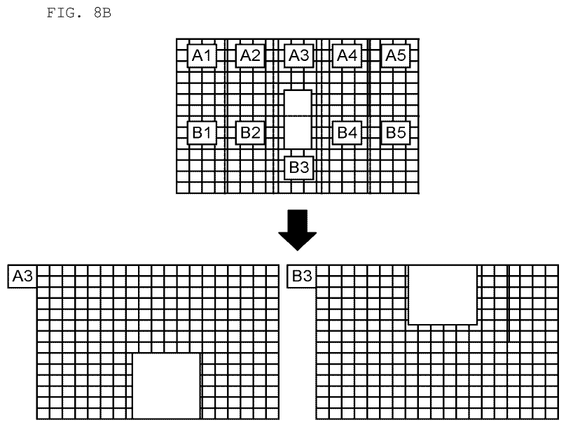

FIGS. 8A and 8B are schematic views illustrating a method of adjusting a shadow area according to the present disclosure.

As illustrated in FIGS. 8A and 8B, another feature of the present disclosure is to finely adjust the shadow area by dividing the road surface projection image of the light output device 200 into a plurality of groups. Specifically, the controller 300 may compare the previous road surface projection image with the current road surface projection image based on the external environmental information, identify an update area whose change has occurred, and calculate light output data on an image of a group including an updated specific area among the plurality of groups to provide the light output data to the light output device 200. Accordingly, unnecessary lighting changes and energy consumption can be reduced, and in addition, as illustrated in FIG. 8A, when the shadow area is included in one group B3 among the plurality of groups, light pattern information may be calculated only for the image of the corresponding group, and as illustrated in FIG. 8B, when the shadow area is distributed across two or more groups A3 and B3, light pattern information may be calculated for the image of the corresponding group, thereby enabling more precise light control.

The headlamp system for a mobile object of the present disclosure achieves greater precise and real-time responsiveness than the conventional ADB systems. By applying the differential update method, reduced unnecessary data processing and rapid response to changes in the position of oncoming vehicles can be achieved, thereby implementing a safer driving environment.

According to various embodiments of the present disclosure, the headlamp system for a mobile object can reduce the amount of data to be processed or transmitted by applying a differential update method.

In addition, it is possible to improve real-time responsiveness and reduce computational load.

In addition, by enabling precise shadow area setting based on relative X- and Y-axis position coordinates, maintaining an optimal lighting pattern on curved roads and in various driving environments, and prediction-based lighting control by reflecting the steering angle of the steering wheel, the driver's visibility and the prevention of glare to oncoming vehicles can be maximized at the same time.

Although the exemplary embodiments of the present disclosure have been described above, the embodiments disclosed in the present disclosure are not intended to limit the technical spirit of the present disclosure but are only for description. Accordingly, the technical spirit of the present disclosure includes not only each disclosed embodiment, but also a combination of the disclosed embodiments, and furthermore, the scope of the technical spirit of the present disclosure is not limited by these embodiments. In addition, those skilled in the art to which the present disclosure pertains can variously change and modify the present disclosure without departing from the spirit and scope of the appended claims, and all such appropriate changes and modifications should be regarded as belonging to the scope of the present disclosure as equivalents.

### DESCRIPTION OF REFERENCE NUMERALS

1000: headlamp system for mobile object
100: sensor module
200: light output device
210: light source
300: controller
310: internal memory
311: first buffer
312: second buffer
313: third buffer
320: CPU
400: light source driver
500: external memory
600: interface
700: DMA controller
800: UART module

What is claimed is:

1. A headlamp system for a mobile object, comprising:
a controller configured to generate light pattern information based on external environmental information; and
a light output device that includes a plurality of light sources and outputs a road surface projection image generated based on the light pattern information,
wherein, based on the external environmental information, the controller calculates light pattern information, which is data on an image of an update area changed compared to a previous road surface projection image, and provides the light pattern information to the light output device.

2. The headlamp system of claim 1, wherein the light output device generates a road surface projection image by selectively updating an image in the update area based on the light pattern information and maintaining the image in the remaining areas based on a previous road surface projection image.

3. The headlamp system of claim 1, wherein the controller is configured to:
set a changed shadow area as the update area when a change between a shadow area calculated from the external environmental information and a previous shadow area is detected; and
provide light pattern information including coordinate data of the update area to the light output device.

4. The headlamp system of claim 3, wherein the controller detects a change in the shadow area based on a time-dependent difference in position information of an oncoming vehicle acquired from the external environmental information.

5. The headlamp system of claim 3, wherein the controller calculates position information of an oncoming vehicle in the road surface projection image based on angle information and distance information of the oncoming vehicle acquired from the external environmental information.

6. The headlamp system of claim 1, further comprising a memory connected to the light output device and the controller,
wherein the memory includes a plurality of buffers,
the controller alternately selects the plurality of buffers to modify or correct a basic image of the road surface projection image and stores the light pattern information,
the light output device outputs light using light pattern information already stored in at least one of the other buffers while the controller stores the light pattern information in one of the plurality of buffers, and
when the controller completes storing the light pattern information in the any one of the buffers, cyclic switching between the buffers is performed so that the buffer in which storage has been completed is usable for light output.

7. The headlamp system of claim 1, wherein the controller is configured to:
acquire a lane width of a driving road based on the external environmental information; and
generate the light pattern information by correcting a trapezoidal basic image in consideration of the lane width.

8. The headlamp system of claim 7, wherein the controller is configured to:
acquire a curvature of the driving road based on the external environmental information and determine whether the driving road is a straight road or a curved road; and
when the driving road is the curved road, correct the trapezoidal basic image in consideration of the lane width and the curvature to generate the light pattern information.

9. The headlamp system of claim 8, wherein the controller is configured to:
generate curvature information of left and right lane lines of the driving road by applying the following Equation to the left lane line and the right lane line, respectively, based on a curvature coefficient {A₀, . . . , Aₙ} of the left lane line or the right lane line of the driving road included in the external environmental information; and
$$Y = {{\sum }_{i = 0}}^{n} {A}_{i} \cdot {X}^{( n - i )} \qquad [ Equation 3 ]$$
generate the light pattern information by correcting the trapezoidal basic image in consideration of the curvature information (where X denotes lateral (width direction of a vehicle) positions of the left and right lane lines of the driving road, and Y denotes longitudinal (longitudinal direction of the vehicle) positions according to the lateral positions of the left and right lane lines of the driving road).

10. The headlamp system of claim 1, wherein the controller is configured to:
divide the road surface projection image into a plurality of groups;
identify an update area changed compared to a previous road surface projection image based on the external environmental information;
determine a group including the update area; and
calculate light pattern information on an image of the determined group and provide the light pattern information to the light output device.

11. A method of operating a headlamp system for a mobile object, the method comprising:
acquiring external environmental information;
generating, by a controller, light pattern information based on the external environmental information, wherein the light pattern information comprises data on an image of an update area changed compared to a previous road surface projection image;
providing the light pattern information to a light output device comprising a plurality of light sources; and
outputting, by the light output device, a road surface projection image based on the light pattern information by selectively updating an image in the update area while maintaining images in remaining areas based on the previous road surface projection image.

12. The method of claim 11, further comprising:
calculating a shadow area based on the external environmental information;
detecting a change between the shadow area and a previous shadow area;
setting a changed shadow area as the update area; and
including coordinate data of the update area in the light pattern information.

13. The method of claim 12, wherein calculating the shadow area comprises:
acquiring angle information and distance information of an oncoming vehicle from the external environmental information;
calculating a lateral position of the oncoming vehicle using the angle information and the distance information; and
converting the lateral position into position information of the oncoming vehicle in the road surface projection image relative to the light output device.

14. The method of claim 11, further comprising:
storing the light pattern information in one of a plurality of buffers in a memory connected to the controller and the light output device, wherein the plurality of buffers are alternately selected to modify a basic image of the road surface projection image;
outputting light from the light output device using light pattern information stored in another of the plurality of buffers while storing the light pattern information in the one of the plurality of buffers; and
performing cyclic switching between the plurality of buffers upon completing storage of the light pattern information, such that the buffer with completed storage is usable for light output.

15. The method of claim 11, further comprising:
acquiring a lane width and a curvature of a driving road from the external environmental information;
correcting a trapezoidal basic image in consideration of the lane width and the curvature to generate the light pattern information when the driving road is determined to be a curved road;
dividing the road surface projection image into a plurality of groups;
identifying the update area based on the external environmental information; and
calculating the light pattern information for an image of at least one group including the update area
